(19) United States
(12) Patent Application Publication
(10) Pub. No.: US 2012/0046480 A1
(43) Pub. Date: Feb. 23, 2012

(54) DENSE CU BASED THIN FILM AND THE MANUFACTURING PROCESS THEREOF

(76) Inventors: Cheng-Jye Chu, Kaohsiung (TW); Chih-Hung Chen, Kaohsiung (TW)

(21) Appl. No.: 12/860,035

(22) Filed: Aug. 20, 2010

(51) Int. Cl. C07F 1/08; B05D 3/02

(52) U.S. Cl. 556/9; 427/383.1; 556/15; 556/110; 556/112

(57) ABSTRACT

The disclosure provides a dense Cu thin film, a dense CuO thin film and the manufacturing process applied in metallization process of ultra-large scale integration (ULSI), which uses a two-step growth consisting of pre-deposition and annealing to form a dense Cu thin film or a dense CuO thin film. In the process, a copper-containing metal-organic complex is used as precursor and a reducing gas is used as carrier gas. The precursor is carried to a reactive system with a substrate by a carrier gas and pre-deposit a CuO thin film on the substrate under lower temperature. Next, stop supplying the precursor and raise the temperature or offer other energy to anneal the thin film with hydrogen gas or reducing gas, which reduces the CuO thin film to a smooth and dense Cu thin film. Then, choosing oxide containing gas as the react gas obtains the CuO thin film.

### BACKGROUND

1. Technical Field

The disclosure provides a dense Cu based thin film and the manufacturing process thereof, and more particularly to a method for forming a dense Cu and CuO thin films. The method includes the first step of pre-depositing Cu₂O, and then annealing to reduce Cu₂O to form a Cu thin film or oxidizing Cu₂O to form a CuO thin film. Both the Cu thin film and the CuO thin film fabricated by this method are smooth and dense.

2. Related Art

Metallization is a process of connecting the transistors on silicon wafer by metal line to form an integrated circuit. When the process technology develops from very-large scale integration (VLSI) to ultra-large scale integration (ULSI), the integrity and speed of device will increase over 0.25 μm, which will improve current density substantially (10⁵ A/cm²) causing electromigration effects. As metal atoms move along the grain boundary resulting in the sectional area of metal line decreasing, the resistance of metal interconnecting line will increase causing resistance capacitance (RC) time delay and decrease of device reliability.

Aluminum is a widely used conducting material in integrated circuits. However, silicon and aluminum have a specified solid solubility, resulting in the contacts between aluminum and silicon spiking in a multi-level interconnect system, increasing contact current leakage. To solve this problem, TiN/Ti alloy or TiW are generally deposited as a diffusion barrier. However, when integrity is below 0.25 μm, the resistivity, the electromigration of Al and the barrier ability of TiN can not fit to the request. Therefore, a metallization process, with low resistivity, high electromigration, deep sub-micron size (<0.25 μm), low metal diffusion coefficient, low ohmic contact, thermally stable, and diffusion barrier of high adherence, is needed urgently by the industry.

Cu and TaN have received increased attention as metal line and diffusion barrier material, due to the high adherence between TaN and Cu, their higher melting point, and thermal stability, which is currently deposited by sputtering physical vapor deposition. In addition, the resistivity of Cu is lower than that of Al(rCu_{(20° C.)}=1.645 μW-cm; rAl_{(20° C.)}=2.825 μW-cm), so that electromigration is better at high current density (10⁹ A/cm²). Cu and TaN are thus highly suitable for the very-large scale integration process. Depositing Cu thin film by metalized organic chemical vapor disposition (MOCVD) is a good choice for achieving good step coverage, via-fill capability, and deep sub-micron size of high aspect ratio grooves.

The current chemical vapor disposition process is that the halides of Cu react with oxygen, or different metal-organic precursors are used to grow the Cu film needed in the semiconductor. However, a hybrid membrane of CuO and Cu₂O is obtained instead of the Cu thin film, which makes the oxygen contents in semiconductor hard to control and affects the quality of Cu thin film. Thus a low resistivity, smoother, and denser Cu film cannot be obtained from this method.

U.S. Pat. No. 7,166,732, U.S. Pat. No. 7,241,912, and U.S. Pat. No. 7,371,880, issued to Xu et al, disclose novel copper (I) amidinates as copper precursors and their synthesis. The deposition of copper thin films with useful electrical properties and good adhesion to the barrier layer, are achieved by the process and the precursors. However, they failed to mention that an even surface of Cu-thin film can be formed by this copper (I) amidinate precursor.

U.S. Pat. No. 6,511,609, issued to Jan et al, discloses a novel method of Cu seed layer deposition for ULSI metallization. The prepared substrate was sunk in a replacing solution which contains CuSO₄.5H₂O and other reactant containing Cu ions. A dense copper membrane with a resistance of about 1.85 μΩ·cm was obtained. However, adhesion to the barrier layer was not mentioned.

U.S. Pat. No. 6,194,316, issued to Oda et al, discloses a method for forming a Cu-thin film, which includes the steps of coating a dispersion containing Cu-containing ultrafine particles individually dispersed therein on a semiconductor substrate; and then firing the coated semiconductor substrate in an atmosphere. The specific resistance of the film was found to be 2.0 μΩ·cm. However, to form an even surface of Cu-thin film, a chemical mechanical polishing (CMP) treatment is required to remove the excess Cu present on the surface of the substrate, which Cu film is likely to be peeled off.

There are some other researches described which change different operating conditions, such as various adsorption amounts, reacting temperature, annealing temperature, plasma, and ligands, but a Cu film with low resistivity, smooth, and dense is still not obtained.

### SUMMARY

The disclosure has been developed to solve the previously described problems of fabricating Cu thin film and CuO thin film associated with conventional techniques, and it is accordingly an objective of the disclosure to provide a valid and practicable method of forming a Cu thin film and a CuO thin film with excellent qualities.

The primary objective of the disclosure is to provide a dense Cu thin film and a dense CuO thin film, which are manufactured by chemical vapor deposition. The thin films mainly consist of copper-containing metal-organic complex. A precursor pre-deposited on a substrate is annealed to form a dense Cu thin film, or oxidized to form smooth and dense Cu thin film and CuO thin film.

The another objective of the disclosure is to provide a method of forming a dense Cu thin film and a dense CuO thin film, which mainly uses two-step growth processes by chemical vapor deposition. The method includes the steps of pre-depositing Cu₂O and reducing Cu₂O to form Cu thin film by annealing, or oxidizing the pre-deposited Cu₂O to CuO to form smooth and dense Cu thin film and CuO thin film.

In order to achieve the first objective, the disclosure provides a dense Cu thin film and a dense CuO thin film, which mainly consisting of copper-containing metal-organic complex include:

a precursor, pre-deposited on a substrate with a first temperature in a range of from 25° C. to 600° C. to form a Cu₂O thin film, wherein the Cu₂O thin film is then annealed and reduced with a second temperature in a range of from 50° C. to 650° C. to form a dense Cu thin film on the substrate; or

annealed and oxidized with a second temperature in a range of from 50° C. to 650° C. to form a dense CuO thin film on the substrate.

In order to achieve the second objective, the disclosure provides a method of forming a dense Cu thin film and a dense CuO thin film, which mainly includes the steps of:

choosing a copper-containing metal-organic complex as a precursor;

using a carrier gas to carry the precursor into a reactive system including a substrate, wherein the carrier gas includes a reducing gas participating in the reaction or an inert gas not participating in the reaction;

pre-depositing the precursor on the substrate with a first temperature in a range of from 25° C. to 600° C. to form a Cu₂O thin film;

annealing with a second temperature in a range of from 50° C. to 650° C. and reducing the Cu₂O thin film to form a Cu thin film on the substrate; or

annealing with a second temperature in a range of from 50° C. to 650° C. and oxidizing the Cu₂O thin film to form a CuO thin film on the substrate.

According to the disclosure, a proper Cu containing metal-organic precursor is chosen to deposit a dense Cu₂O thin film on a substrate and then reduce Cu₂O to form a smooth and dense Cu thin film by annealing, or oxidize the pre-deposited Cu₂O to form a smooth and dense CuO thin film, which will improve the purity and the quality of Cu thin film and CuO thin film.

The invention itself, though conceptually explained above, can be best understood by referencing to the following description, taken in conjunction with the accompanying drawings.

### BRIEF DESCRIPTION OF THE DRAWINGS

FIG. 1 is a diagram of metal-organic chemical vapor deposition;

FIG. 2 is XRD pattern of deposited Cu₂O film;

FIG. 3 is Cu LMM Auger patterns of (a) pre-depositing Cu₂O for 30 minutes and (b) reducing by ethanol for 3 minutes;

FIG. 4 is O1s XPS patterns of (a) pre-depositing Cu₂O for 30 minutes and (b) reducing by ethanol for 3 minutes; and

FIG. 5 is 30K-fold SEM image of Cu deposited by two-step growth.

### DETAILED DESCRIPTION

The disclosure provides a dense Cu thin film and a dense CuO thin film, which mainly consisting of copper-containing metal-organic complex include:

a precursor, pre-deposited on a substrate with a first temperature in a range of from 25° C. to 600° C. to form a Cu₂O thin film, wherein the Cu₂O thin film is then annealed and reduced with a second temperature in a range of from 50° C. to 650° C. to form a dense Cu thin film on the substrate; or

annealed and oxidized with a second temperature in a range of from 50° C. to 650° C. to form a dense CuO thin film on the substrate.

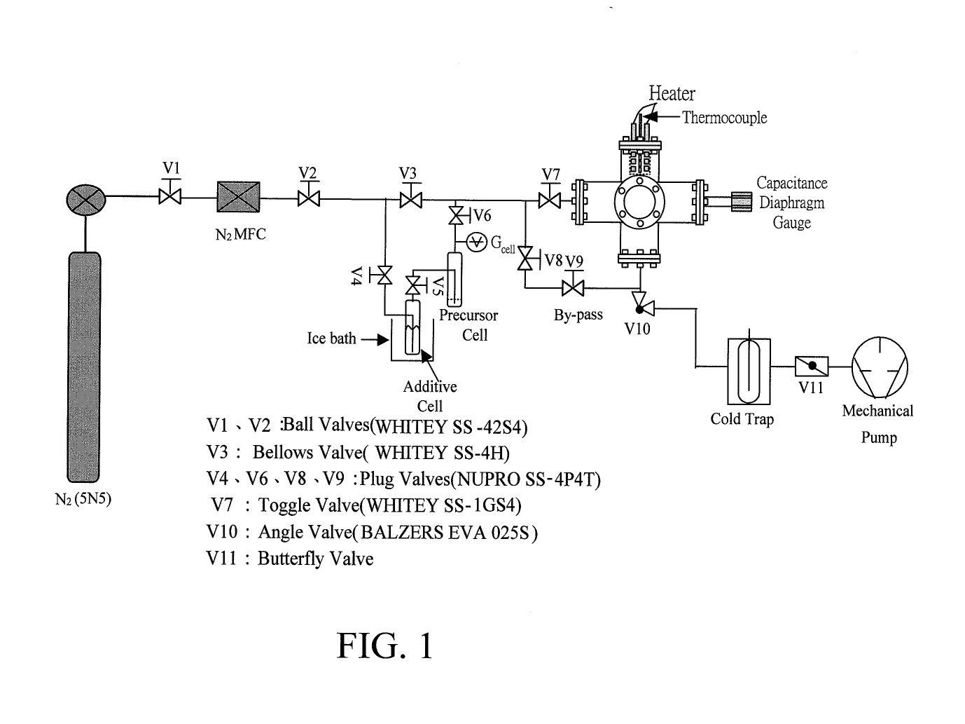

Additionally, a novel method of forming a dense Cu thin film and a dense CuO thin film (see FIG. 1), which mainly includes the steps of:
choosing a copper-containing metal-organic complex as a precursor;
the precursor carried to a reactive system with a substrate by a carrier gas;
pre-depositing the precursor onto the substrate to form a Cu₂O thin film;
annealing and reducing the Cu₂O thin film to form a Cu thin film on the substrate; or
annealing and oxidizing the Cu₂O thin film to form a CuO thin film on the substrate.

It is deserved to be is worth mentioned mentioning that there are two factors determining the resistivity of metal thin film. One is the contents of impurities; the other is the density of thin film. Wherein the larger grain size is and the smaller grain boundary size is, the higher density is, relatively. The pre-deposition and annealing temperature of two-step growth can satisfy the said factors efficiently. From the said In this distribution, the method fabricating the Cu thin film and the CuO thin film of the disclosure uses two-step growth process to reduce the pre-deposited Cu₂O to pure Cu thin film on the substrate, or to oxidize the Cu₂O to CuO thin film, so that a smooth and dense film with low resistivity, high reflection, and low roughness is formed. On the other hand, the precursor is only carried within the pre-deposition process. Compare In comparison with to the traditional method of forming Cu film, the precursor consumptions of the precursor will is reduced significantly likewise reducing costs and pollution. In addition, because the pre-deposition temperature is lower, precursor pyrolysis will not break the bonding within the ligands, which keeping the ligands intact and making them reusable. This condition is beneficial to environmental protection, and further solves the environmental problems resulting from the traditional method of forming Cu thin film.

The Cu of the copper-containing metal-organic complex chosen in the disclosure is either copper (I) or copper (II). The complex containing copper (I) is a (β-diketonate), copper (I) L complex, wherein β-diketonate is selected from the group consisting of hexafluoroacetylacetone (hfac), acetylacetone (acac), 2,2,6,6-tetramethyl-3,5-heptanedione (thd), ethyl 3-oxobutanoate (etac), tert-butyl 3-oxobutanoate (btac), and etc. . . . ; L is an electron donating ligand, which is selected from the group consisting of alkyl, alkyl phosphite, alkyl phosphine, alkyne, and silane, such as 1,5-cyclo-octadiene (1,5-COD), vinyltrimethyl-silane (VTMS), vinyltrimethoxy silane (VTMOS), 2-butyne, 2-pentyne, trialkylphosphite, trialkylphosphine and so on. The complex containing copper (II) is a copper (II)(β-diketonate)₂ complex, which is selected from the group consisting of Cu(II)(hfac)₂, Cu(II)(acac)₂, Cu(II)(thd)₂, Cu(II)(btac)₂, Cu(II)(etac)₂ and so on.

The carrier gas, which includes a reducing gas such as hydrogen gas, hydrogen peroxide vapor, water vapor, and alcohol vapor participating in the reaction or an inert gas such as nitrogen gas, helium gas, and silane not participating in the reaction, is chosen to carry the said precursor into the reacting system. Furthermore, additive gas such as hydrogen peroxide vapor, water vapor, and alcohol vapor can contribute to stabilizing the vapor pressure of the precursor.

The pre-depositing step is at a first temperature in a range of from 25° C. to 600° C., the precursor will form a pre-deposited Cu₂O thin film on a proper substrate. Preferably, the first temperature in the pre-depositing step is in a range of from 90° C. to 430° C. And more preferably, the first temperature in the pre-depositing step is in a range of from 150° C. to 350° C., to reduce the fabrication variety. The proper substrate, which is able to contact with Cu interconnecting lines in an IC process, is selected from the group consisting of materials of diffusion barrier, such as titanium oxide, tantalum oxide, and tungsten oxide; materials of insulator layer, such as silicon, silicon oxide, silicon nitride, and titanium oxide; metal materials, such as tungsten and aluminum; dielectric materials, such as silicon, silicon carbon, and tantalum oxide; superconductor and materials contacting with superconductor.

Next, stop the supply of the precursor, and retain the conducting gas or increase the other conducting gases and additive gases. Meanwhile, proceed with annealing at a second temperature in a range of from 50° C. to 650° C. or offer the other energy to reduce Cu₂O to form Cu thin film. Light, heat, plasma, and high energy particle can offer the energy for annealing with the reducing gas consisting of hydrogen gas, hydrogen peroxide vapor, water vapor, and alcohol vapor. If hydrogen gas is used as a reducing gas, Cu₂O will be reduced simply to Cu forming Cu thin film. If carbon monoxide or oxygen is used as annealing gas, Cu₂O will be oxidized to CuO, forming CuO thin film. It is worth mentioning that the first temperature is better in a range of from 90° C. to 430° C., and the second temperature is better in a range of from 150° C. to 450° C. for obtaining a smooth and dense Cu thin film or CuO thin film. More preferably, the first temperature is better in a range of from 150° C. to 350° C., and the second temperature is better in a range of from 200° C. to 400° C., to obtain a smooth and dense Cu thin film or CuO thin film.

The method for forming a Cu thin film and a CuO thin film according to the disclosure will hereinafter be described in more detail with reference to the following working examples, but the disclosure is not restricted to these specific examples at all.

### Example 1

Cu (btac)₂ is used as the precursor, and copper then be deposited on the wafer using a chemical vapor deposition system. A TaN substrate is pre-heated to a temperature of 250° C. in a vacuum of not higher than 10⁻² torr for 2 minutes to remove the organic solvent, and fired in a vacuum atmosphere in the presence of hydrogen gas (hydrogen particle pressure: 10⁻⁹ torr), for 60 minutes while raising the temperature up to 300° C. A Cu₂O thin film is formed on a TaN substrate. Moreover, the substrate is fired in a reducing gas of alcohol vapor for 30 minutes while raising the temperature to 400° C. The Cu₂O thin film will thus be reduced to form Cu film.

### Example 2

The experimental conditions are the same as example 1, in which carbon monoxide is introduced to oxidize the pre-deposited Cu₂O thin film to form a smooth and dense CuO thin film after pre-depositing Cu₂O thin film. The second temperature for annealing is at 200° C. for obtaining a smooth and dense CuO thin film.

### Example 3

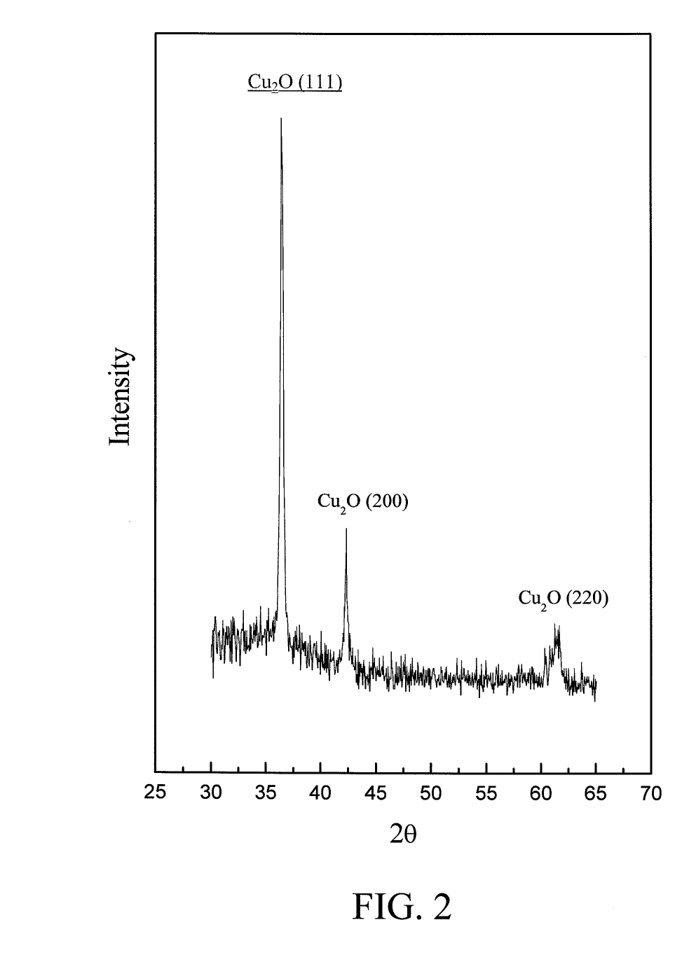

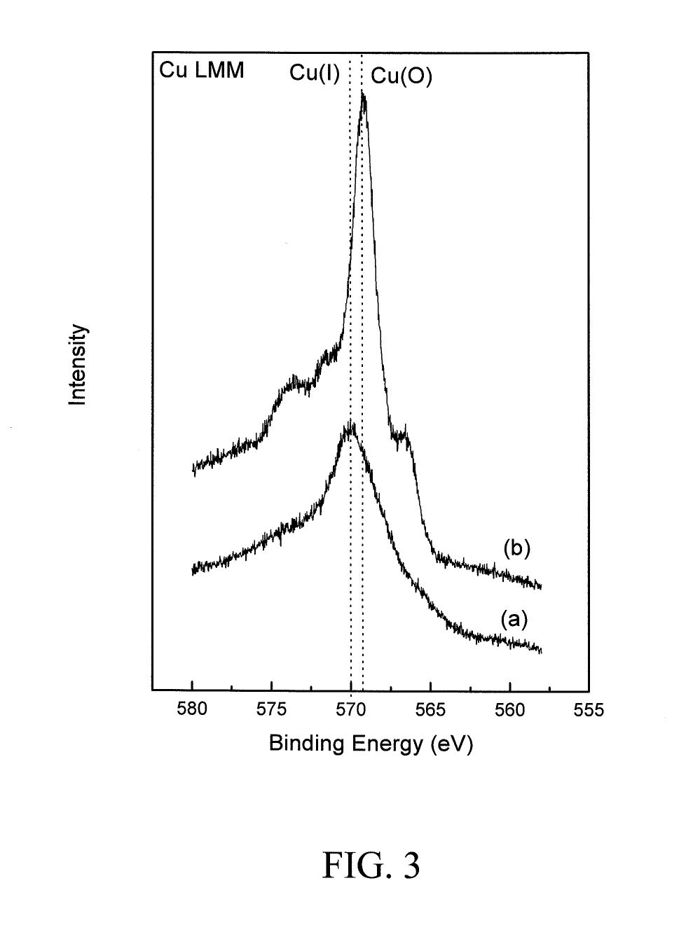

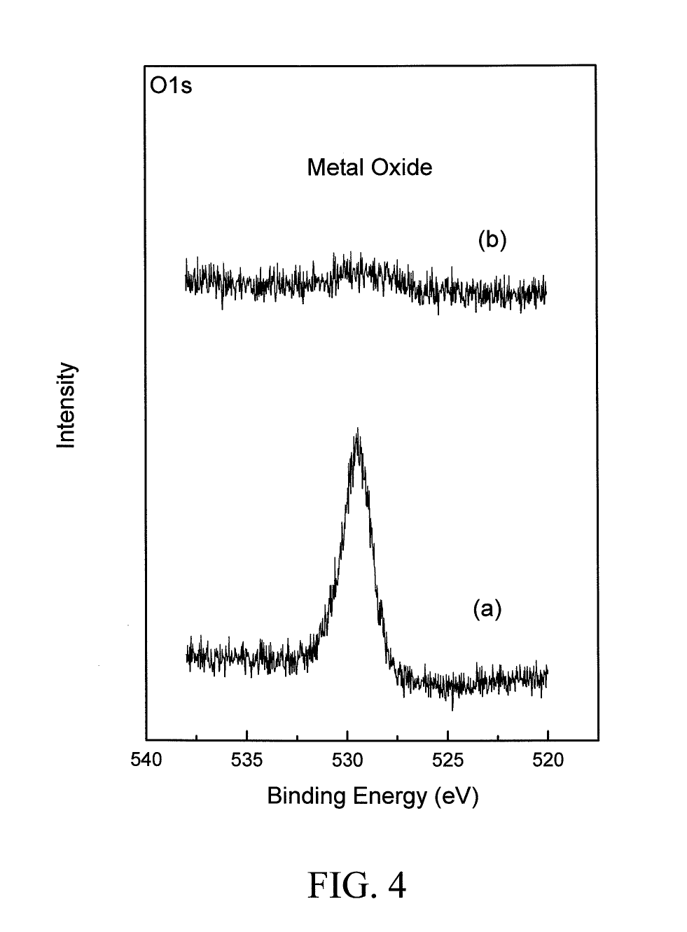

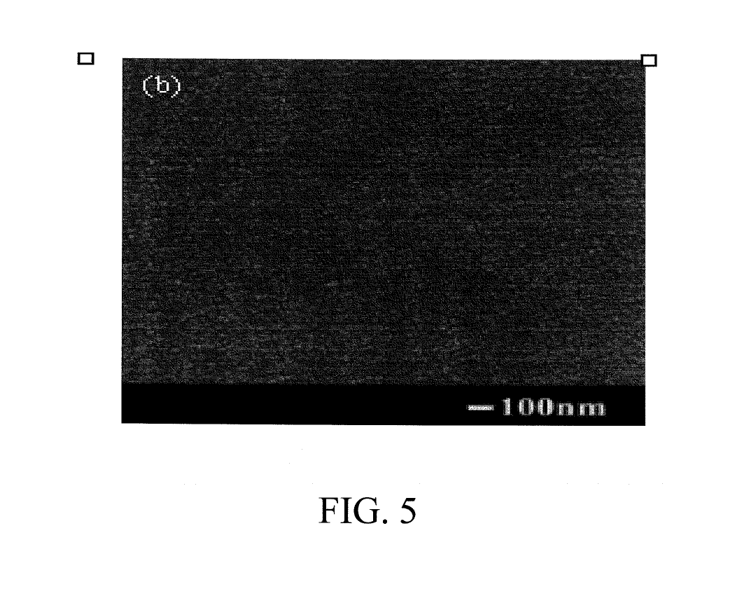

Cu(hfac)₂ is used as the precursor of chemical vapor deposition to proceed two-step growth. In other words, water vapor is added first to pre-deposit Cu₂O thin film on a TaN substrate, and annealing and reducing is then carried out to form Cu film by alcohol vapor. The experimental conditions may include Cu₂O is pre-deposited at a pressure of 0.1 torr at 275° C.; precursor evaporator is at 65° C.; nitrogen gas flows at 7.5 sccm; and add water vapor as carrier gas. The results are shown in FIG. 2. Note in the XRD diagram of FIG. 2, that the peak positions at 2θ=36.4°, 42.2°, and 61.3° correspond to (111), (200), and (220) of Cu₂O respectively and there is no characteristic peak of CuO present in the XRD diagram. The results, conditions of which include nitrogen gas flows at 7.5 sccm to carry alcohol vapor and reduce at a pressure of 0.4 torr at 275° C. for 3 minutes, are shown in FIG. 3, FIG. 4, and FIG. 5.

### Example 4

The experimental conditions are the same as example 3, in which oxygen is introduced to oxidize the pre-deposited Cu₂O thin film to form a smooth and dense CuO thin film after pre-depositing Cu₂O thin film. The second temperature for annealing is at 150˜200° C. for obtaining a smooth and dense CuO thin film.

### Example 5

The experimental conditions are the same as example 4, in which oxygen is introduced to oxidize the pre-deposited Cu₂O thin film to form a smooth and dense CuO thin film after pre-depositing Cu₂O thin film. However, the second temperature for annealing is at 250° C. for quickly obtaining a smooth and dense CuO thin film.

FIG. 3 is the Cu LMM Auger patterns. A Cu LMM Auger should be used to observe the presence of Cu(0) and Cu(I). From the Cu LMM Auger patterns, it is found that Cu(0) and Cu(I) are present at 568.2 and 570.1 eV respectively. But Cu(0) and Cu(I) are still not distinguished from the Cu LMM Auger patterns, because there are some overlaps within the LMM patterns of Cu(0) and Cu(I). We must therefore analyze the quantity of the oxygen contained in thin film. From FIG. 4, it is observable that the peak position of oxygen is not very obvious after annealing by alcohol vapor for 3 minutes, which means there is almost no oxygen present. It is therefore proved that Cu₂O is indeed reduced to Cu thin film, instead of CuO thin film or Cu₂O thin film.

In respect of structure, FIG. 5 is the SEM image of Cu deposited by two-step growth. It is observable that the surface morphology of Cu thin film deposited by two-step growth is extremely dense, without any void. This is because Cu thin film grown directly will crack to form Cu under higher temperatures. If there are some Cu-cores in the defects of TaN substrate with high resistivity, the following precursor pyrolysis deposition will occur on Cu-cores to form Cu, where the Cu atom can be used to absorb the medium produced from precursor pyrolysis, resulting in larger and denser grains. In the meantime, Hfac produced from pyrolysis will react with Cu to form Cu(hfac) and then desorb, which is a etching reaction and also a reason why film is not dense. On the contrary, Cu₂O is produced first within a two-step pre-deposition process, meaning deposition without selectivity will occur after precursor pyrolysis. Furthermore, the surface free energy of CuO is lower, making it easier to wet the substrate surface, so that CuO will plate on the surface uniformly. In addition, there is no etching reaction of Hfac when annealing, and the crystalline Cu begins to nucleate and regrow from the interface, so that a smooth and dense film can be deposited.

As has been described above in detail, the forming method of Cu thin film and CuO thin film according to the disclosure definitely improves the quality of Cu thin film, replaces the traditional method of directly forming CuO thin film, lowers the cost of process, contributes to environmental protection, and thus permits the formation of a conductive, uniform and fine pattern.

While the disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A dense Cu based thin film mainly consisting of copper-containing metal-organic complex comprises:
a precursor, pre-deposited on a substrate with a first temperature in a range of from 90° C. to 430° C. to form a Cu₂O thin film, wherein the Cu₂O thin film is then annealed with a second temperature in a range of from 50° C. to 650° C. and obtained to be a dense Cu based thin film on the substrate.

2. The dense Cu based thin film as claimed in claim 1, wherein the precursor is a (β-diketonate) copper (I)L complex, wherein:
β-diketonate is selected from the group consisting of hfac, acac, thd, etac, and btac; and
L is an electron donating ligand, which is selected from the group consisting of alkyl, alkyl phosphite, alkyl phosphine, alkyne, and silane.

3. The dense Cu based thin film as claimed in claim 2, wherein the precursor is selected from the group consisting of 1,5-cyclo-octadiene (1,5-COD), vinyltrimethyl-silane (VTMS), vinyltrimethoxy silane (VTMOS), 2-butyne, 2-pentyne, trialkylphosphite, and trialkylphosphine.

4. The dense Cu based thin film as claimed in claim 1, wherein the precursor is a copper (II)(β-diketonate)₂ complex, wherein:
β-diketonate is selected from the group consisting of hfac, acac, thd, etac, and btac.

5. The dense Cu based thin film as claimed in claim 4, wherein the precursor is selected from the group consisting of Cu(II)(hfac)₂, Cu(II)(acac)₂, Cu(II)(thd)₂, Cu(II)(btac)₂, and Cu(II)(etac)₂.

6. A method for forming a dense Cu thin film comprises the following steps of:
(A) choosing a copper-containing metal-organic complex as a precursor;
(B) using a carrier gas to carry the precursor into a reactive system comprising a substrate, wherein the carrier gas comprises a reducing gas participating in the reaction or an inert gas not participating in the reaction;
(C) pre-depositing the precursor on the substrate with a first temperature in a range of from 90° C. to 430° C. to form a Cu₂O thin film; and
(D) annealing with a second temperature in a range of from 50° C. to 650° C. and reducing the Cu₂O thin film to form a Cu thin film on the substrate.

7. The method for forming a dense Cu thin film as claimed in claim 6, wherein the copper-containing metal-organic complex is a (β-diketonate) copper (I)L complex, wherein:
β-diketonate is selected from the group consisting of hfac, acac, thd, etac, and btac; and
L is an electron donating ligand, which is selected from the group consisting of alkyl, alkyl phosphite, alkyl phosphine, alkyne, and silane.

8. The method for forming a Cu thin film as claimed in claim 6, wherein the copper-containing metal-organic complex is selected from the group consisting of 1,5-cyclo-octadiene (1,5-COD), vinyltrimethyl-silane (VTMS), vinyltrimethoxy silane (VTMOS), 2-butyne, 2-pentyne, trialkylphosphite, and trialkylphosphine.

9. The method for forming a Cu thin film as claimed in claim 6, wherein the copper-containing metal-organic complex is a copper (II)(β-diketonate)₂ complex, wherein:
β-diketonate is selected from the group consisting of hfac, acac, thd, etac, and btac.

10. The method for forming a Cu thin film as claimed in claim 9, wherein the copper-containing metal-organic complex is selected from the group consisting of Cu(II)(hfac)₂, Cu(II)(acac)₂, Cu(II)(thd)₂, Cu(II)(btac)₂, and Cu(II)(etac)₂.

11. The method for forming a Cu thin film as claimed in claim 6, wherein the carrier gas further comprises an additive gas to stabilize the vapor pressure of the precursor.

12. The method for forming a Cu thin film as claimed in claim 11, wherein the additive gas is selected from the group consisting of hydrogen peroxide vapor, water vapor, and alcohol vapor.

13. The method for forming a Cu thin film as claimed in claim 6, wherein the first temperature is in a range of from 150° C. to 400° C., and the second temperature is in a range of from 200° C. to 400° C.

14. The method for forming a Cu thin film as claimed in claim 8, wherein a reducing gas, selected from the group consisting of hydrogen gas, hydrogen peroxide vapor, water vapor, and alcohol vapor, is added when annealing and reducing the Cu₂O thin film.

15. A method for forming a dense CuO thin film comprises the following steps of:
(A) choosing a copper-containing metal-organic complex as a precursor;
(B) using a carrier gas to carry the precursor into a reactive system comprising a substrate by a carrier gas, wherein the carrier gas comprises a reducing gas participating in the reaction or an inert gas not participating in the reaction;
(C) pre-depositing the precursor on the substrate with a first temperature in a range of from 90° C. to 430° C. to form a Cu₂O thin film; and
(D) annealing with a second temperature in a range of from 50° C. to 650° C. and oxidizing the Cu₂O thin film to form a CuO thin film on the substrate.

16. The method for forming a CuO thin film as claimed in claim 15, wherein the copper-containing metal-organic complex is a (β-diketonate) copper (I) L complex, wherein:
β-diketonate is selected from the group consisting of hfac, acac, thd, etac, and btac; and
L is an electron donating ligand, which is selected from the group consisting of alkyl, alkyl phosphite, alkyl phosphine, alkyne, and silane.

17. The method for forming a CuO thin film as claimed in claim 16, wherein the copper-containing metal-organic complex is selected from the group consisting of 1,5-cyclo-octadiene (1,5-COD), vinyltrimethyl-silane (VTMS), vinyltrimethoxy silane (VTMOS), 2-butyne, 2-pentyne, trialkylphosphite, and trialkylphosphine.

18. The method for forming a CuO thin film as claimed in claim 15, wherein the copper-containing metal-organic complex is a copper (II)(β-diketonate)₂ complex, wherein:
β-diketonate is selected from the group consisting of hfac, acac, thd, etac, and btac.

19. The method for forming a CuO thin film as claimed in claim 18, wherein the copper-containing metal-organic complex is selected from the group consisting of Cu(II)(hfac)₂, Cu(II)(acac)₂, Cu(II)(thd)₂, Cu(II)(btac)₂, and Cu(II)(etac)₂.

20. The method for forming a CuO thin film as claimed in claim 15, wherein the first temperature is in a range of from 150° C. to 400° C., and the second temperature is in a range of from 200° C. to 400° C.
